(19) United States
(12) Patent Application Publication
(10) Pub. No.: US 2018/0173858 A1
(43) Pub. Date: Jun. 21, 2018

(54) IMAGE PROCESSING SYSTEM, SERVER APPARATUS, CONTROLLING METHOD THEREOF, AND PROGRAM

(71) Applicant: NEC Corporation, Tokyo (JP)

(72) Inventor: Daisuke MIZUNO, Tokyo (JP)

(21) Appl. No.: 15/579,068

(22) PCT Filed: Jun. 3, 2016
(86) PCT No.: PCT/JP2016/066546

§ 371 Date: Dec. 1, 2017

(30) Foreign Application Priority Data
Jun. 5, 2015 (JP) 2015-114741

(51) Int. Cl. G06F 21/10; G06F 21/62; H04N 1/387; H04N 21/274; G06F 17/30

(52) U.S. Cl. CPC G06F 21/10; G06F 21/6218; G06F 17/30244; H04N 21/274; H04N 1/387

(57) ABSTRACT

An image processing system includes a terminal apparatus(es), and a server apparatus that connects to the terminal apparatus(es). The terminal apparatus includes: an imaging part that captures image of a subject, and generates a captured image; and an image transmitting part that, in a case where the imaging part generated the captured image, transmits the captured image to the server apparatus. In a case where the image transmitting part transmitted the captured image to the server apparatus, the image transmitting part deletes the captured image from the own terminal apparatus. The server apparatus includes: a determining part that determines whether or not the captured image received includes predetermined information; and an image modifying part that, in a case where the captured image received includes predetermined information, performs a predetermined process including at least a process of decreasing visibility of the captured image, or of preventing outputting the captured image.

### REFERENCE TO RELATED APPLICATION

The present invention is based upon and claims the benefit of the priority of Japanese patent application No. 2015-114741, filed on Jun. 5, 2015, the disclosure of which is incorporated herein in its entirety by reference thereto. The present invention relates to an image processing system, a server apparatus, a controlling method thereof, and a program.

### BACKGROUND

### Field

In recent years, because of spread of SNS (Social Networking Service), etc., it is getting easier to publish an image captured by a camera (a captured image) via a network. However, even if the captured image includes a copyrighted material(s) being a target of copyright protection, it is easily possible to save, duplicate and publish the captured image, thus, there is a case where infringement of copyright is caused without intension.

In Patent Literature 1, there is described a technique that performs a process(es) of color conversion, electronic watermarking combining, etc. on an image data before reading a manuscript and accumulating the image data in a HDD (Hard Disk Drive), in a case where the manuscript is a bill, or a document to be needed to protect copyright, and so on.

In Patent Literature 2, there is described a technique that collates viewed video data made it be in a viewable state at a site on a network. The technique described in Patent Literature 2 comprises a video database where a plurality of registration video data are registered as information. Then, the technique described in Patent Literature 2 collates between the viewed video data and the registration video data that is registered in the video database. And, in a case where the viewed video data registered in the video database, the technique described in Patent Literature 2 adds identifier data to the viewed video data, and deletes the viewed video data to which the identified data is added.

### CITATION LIST

### Patent Literature

### [Patent Literature 1]

Japanese Patent Kokai Publication No. 2006-050082A

### [Patent Literature 2]

Japanese Patent Kokai Publication No. 2009-070349A

### SUMMARY

### Technical Problem

The disclosure of the above Patent Literature is incorporated herein by reference thereto. The following analysis has been given by the present invention.

As described above, in order to prevent an infringement of copyright, it is required to determine whether or not that a copyrighted material(s) being a target of copyright protection is included in a captured image. Here, in order to determine an existence of a copyrighted material(s), it is necessary to prepare in advance a database in which the copyrighted material(s) that is a target of determination is registered. However, there are various types of copyrighted materials being the target of the copyright protection. As types of the copyrighted materials being the target of the copyright protection increases, a size of the database in which the copyrighted material(s) that is a target of the determination is registered increases. In addition, as the size of the database increases, load for determining an existence of the copyrighted material(s) increases.

The technique described in Patent Literature 1 limits its target for determination to a bill, etc., and, there is no recitation and no suggestion regarding adapting to various types of the copyrighted material(s). Further, assumed that the technique described in Patent Literature 1 adapts to the various types of the copyrighted material(s), load on an image processing apparatus used by a user increases.

The technique described in Patent Literature 2 is for preventing publishing an image including a copyrighted material(s). However, the technique described in Patent Literature 2 cannot prevent saving, and duplicating a captured image including the copyrighted material(s) in an information processing apparatus (a PC (Personal Computer), etc.) used by a user.

Therefore, it is an object of the present invention to provide an image processing system, a server apparatus, a controlling method thereof and a program that contribute to appropriately managing a captured image, while decreasing load on a terminal apparatus used by a user.

### Solution to Problem

According to a first aspect, there is provided an image processing system. The image processing system comprises a terminal apparatus(es), and a server apparatus that connects to the terminal apparatus(es).

The terminal apparatus comprises an imaging part that captures image of a subject, and generates a captured image.
Further, the terminal apparatus comprises an image transmitting part that, in a case where the imaging part generated the captured image, transmits the captured image to the server apparatus. In a case where the image transmitting part transmitted the captured image to the server apparatus, the image transmitting part deletes the captured image from the own terminal apparatus.
The server apparatus comprises a determining part that determines whether or not the captured image received includes predetermined information.
Further, the server apparatus comprises an image modifying part that, in a case where the captured image received includes predetermined information, performs a predetermined process including at least a process of decreasing visibility of the captured image, or of preventing outputting the captured image.

According to a second aspect, there is provided a server apparatus. The server apparatus comprises an image receiving part that receives a captured image from a terminal apparatus.

Further, the server apparatus a determining part that determines whether or not the captured image received includes predetermined information.
Further, the server apparatus comprises an image modifying part that, in a case where the captured image received includes the predetermined information, performs a predetermined process including at least a process of decreasing visibility of the captured image, or of preventing outputting the captured image.

According to a third aspect, there is provided a controlling method for a server apparatus. The server apparatus comprises an image receiving part that receives an image from a terminal apparatus. The controlling method comprises a step of determining whether or not the image received includes predetermined information.

Further, the controlling method comprises a step of performing a predetermined process including at least a process of decreasing visibility of the captured image, or of preventing outputting the captured image. Note that, the present method is associated with a particular machine, which is a server apparatus that connects to a terminal apparatus(es).

According to a fourth aspect, there is provided a program causing a computer that controls a server apparatus to execute. The server apparatus comprises an image receiving part that receives an image from a terminal apparatus. The program causes the computer to execute the processing of determining whether or not the image received includes predetermined information.

Further, the program causes the computer to execute the processing of performing a predetermined process including at least a process of decreasing visibility of the captured image, or of preventing outputting the captured image.

Note that, this program can be stored in a computer-readable storage medium. The storage medium can be a non-transient one such as semiconductor memory, hard disk, magnetic storage medium, and optical storage medium. The present invention can be embodied as a computer program product.

### Advantageous Effects of Invention

According to each aspect, an image processing system, a server apparatus, a controlling method thereof and a program that contribute to appropriately managing a captured image, while decreasing load on a terminal apparatus used by a user are provided.

### BRIEF DESCRIPTION OF THE DRAWINGS

FIG. 1 is a block diagram illustrating an example of a configuration of an image processing system according to an example embodiment.

FIG. 2 is a block diagram illustrating an example of a total configuration of an image processing system 1 according to a first example embodiment.

FIG. 3 is a block diagram illustrating an example of the image processing system 1 according to the first example embodiment.

FIG. 4 is a flowchart of an example of operations of a server apparatus 10 and a terminal apparatus 20.

FIG. 5 is a block diagram illustrating an example of a total configuration of an image processing system la according to a second example embodiment.

FIG. 6 is a block diagram illustrating an example of the image processing system la according to the second example embodiment.

### MODES

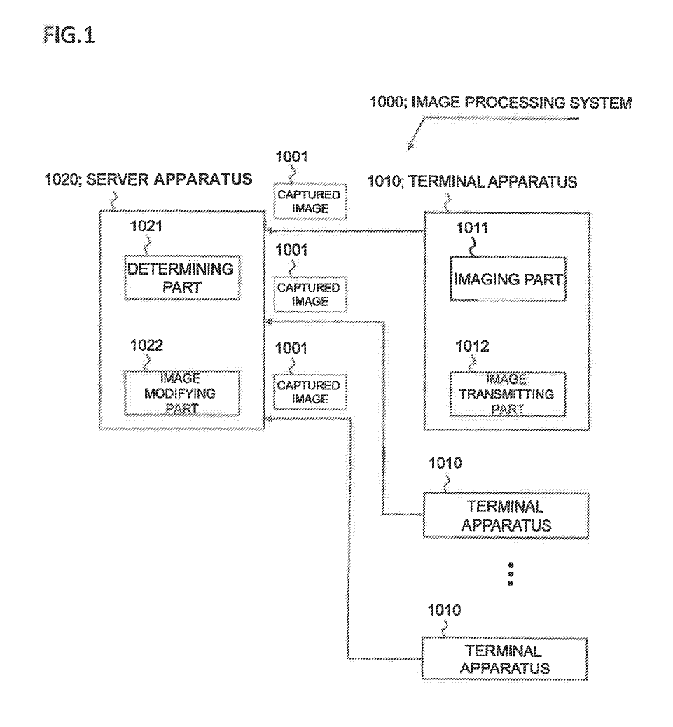

First, a summary of an example embodiment of the present invention will be given using FIG. 1. Note that, drawing reference symbols in the summary are given to each element for convenient as examples solely for facilitating understanding, and the description of the summary is not intended to suggest any limitation.

As described above, an information processing system that contributes to appropriately managing a captured image while decreasing load on a terminal apparatus used by a user is demanded.

Therefore, an image processing system 1000 shown in FIG. 1 is provided. The image processing system 1000 comprises a terminal apparatus(es) 1010, and a server apparatus 1020 connecting to the terminal apparatus 1010. The terminal apparatus 1010 comprises an imaging part (may be termed as “camera”) 1011, and an image transmitting part 1012. In addition, the server apparatus 1020 comprises a determining part 1021, and an image modifying part 1022. Note that, in FIG. 1, the same signs are given to more than two terminal apparatuses 1010, and the same signs are given to more than two captured images 1001. But, this is not intended to indicate that more than two terminal apparatuses 1010 are same, and that more than two captured images 1001 are same. Respective terminal apparatuses 1010 and respective captured images 1001 are respectively independent.

The terminal apparatus 1010 is an information processing apparatus used by a user. On the other hand, the server apparatus 1020 is an information processing apparatus with higher processing ability than that of the terminal apparatus 1010.

The imaging part 1011 of the terminal apparatus 1010 captures image of a subject, and generates a captured image (captured image data) 1001. Here, assumed that the captured image a static image and/or a video. In addition, although there are various types of a data format of an image, any type of data format can be used. Note that, in explanations below, the captured image data is also just referred to as a captured image.

In a case where the imaging part 1011 generated the captured image 1001, the image transmitting part 1012 of the terminal apparatus 1001 transmits the captured image 1001 to the server apparatus 1020. In a case where the image transmitting part 1012 transmitted the captured image 1001 to the server apparatus 1020, the image transmitting part 1012 deletes the captured image 1001 from the terminal apparatus 1010. Namely, the terminal apparatus 1010 does not store the generated captured image 1001 in a storage region (not shown in the drawings) in the terminal apparatus 1010.

The server apparatus 1020 connects to the terminal apparatus(es) 1010, and receives the captured image from the terminal apparatus 1010. Then, in a case where the determining part 1021 of the server apparatus 1020 received the captured image 1010 from the terminal apparatus 1010, the determining part 1021 of the server apparatus 1020 determines whether or not the captured image 1001 received includes predetermined information. For example, the determining part 1021 may determine whether or not a certain subject (a copyrighted material being a target of copyright protection) is included in the captured image. Note that, in explanations below, assumed that a copyrighted material(s) means a copyrighted material(s) being a target of copyright protection.

In a case where the captured image 1001 received includes the predetermined information, the image modifying part 1022 of the server apparatus 1020 performs a predetermined process including at least a process of decreasing visibility of the captured image 1001, or of preventing outputting the captured image 1001. For example, in a case where a copyrighted material(s) includes in a captured image, the image modifying part 1022 may perform a process(es) including decreasing the visibility of the captured image (for example, decreasing resolution of the captured image), and so on.

As described above, the server apparatus 1020 performs determining whether or not the copyrighted material(s) exists in the captured image. Accordingly, the image processing system 1000 contributes to decreasing load on the terminal apparatus 1010 used by a user. Furthermore, in the image processing system 1000, the terminal apparatus 1010 deletes the captured image 1001 from the terminal apparatus 1010. The server apparatus 1020 modifies an image so as to suppress storing, duplicating and publishing the image including predetermined information (a predetermined subject, etc.). Therefore, the image processing system 1000 contributes to appropriately managing the captured image 1001 while decreasing load on the terminal apparatus used by a user.

### First Example Embodiment

A first example embodiment will be described with reference to the drawings.

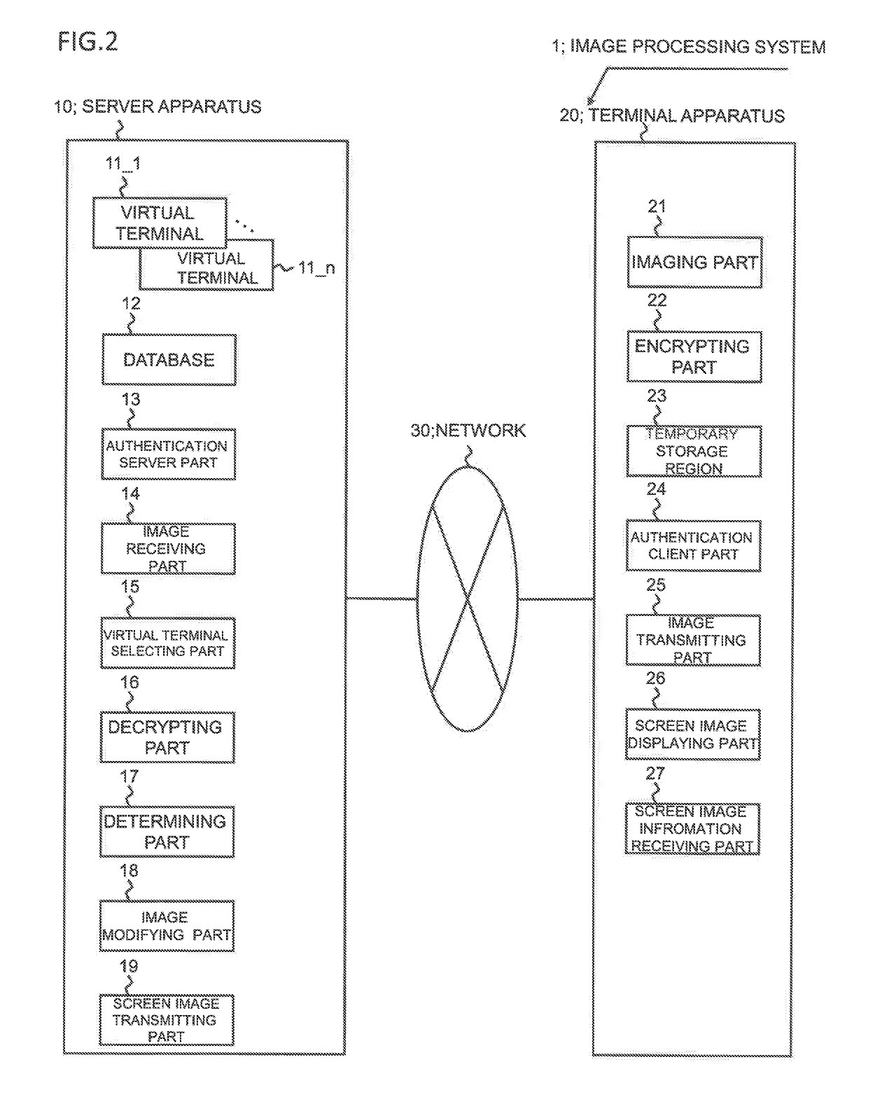

FIG. 2 is a block diagram illustrating an example of total configuration of an image processing system 1 according to the present example embodiment. The image processing system 1 comprises a server apparatus 10 and a terminal apparatus(es) 20. The server apparatus 10 and respective terminal apparatuses 20 are connected via a network 30. Note that, in FIG. 2, one terminal apparatus 20 is shown, but this is not intended to limit the number of the terminal apparatuses 20.

The network 30 may be a phone network, a mobile phone network, and WiFi (Wireless Fidelity), etc. Although there are various kinds of schemes as a method for realizing the network 30, any method can be used. Assumed that a scheme of the network 30 differs according to an embodiment that realizes the image processing system 1.

The server apparatus 30 is an information processing apparatus connecting to the network 30, and comprising a virtual terminal(s) 11_1 to 11_n (the n is a natural number not less than 1). If the server apparatus 10 realizes functions described herein, any apparatus can be used as the server apparatus 10.

The terminal apparatus 20 is an information processing apparatus used by a user, and comprises an imaging function (camera). For example, the terminal apparatus 20 may be a smart phone, a mobile phone, a digital camera, a tablet computer, a game device, and a PDA (Personal Digital Assistant), etc. If the terminal apparatus 20 can realize functions described herein, any apparatus can be used as the terminal apparatus 20.

Next, details on an internal configuration of the terminal apparatus 20 will be described.

The terminal apparatus 20 comprises an imaging part 21, an encrypting part 22, a temporary storage region 23, an authentication client part 24, an image transmitting part 25, a screen image displaying part 26, and a screen image receiving part 27. For simplicity, FIG. 2 mainly shows modules relevant to the terminal apparatus 20 according to the present example embodiment.

Respective modules of the terminal apparatus 20 may be realized by a computer program that causes the terminal apparatus 20 to perform by a computer mounted on the terminal apparatus 20 by using its modules.

The imaging part 21 captures image of a subject, and generates a captured image. The imaging part 21 comprises a lens, and an image sensor (not shown in the drawings), etc. The imaging part 21 outputs the generated captured image to the encrypting part 22.

The imaging part 21 may generate a static image as the captured image. In a case where the imaging part 21 generates the static image as the captured image, a data format of the captured image may be JPEG (Joint Photographic Experts Group) format, or RAW format, etc., any data format can be used.

In other ways, the imaging part 21 may generate a video as the captured image. In a case where the imaging part 21 generates the video as the captured image, a data format of the captured image may be an MPEG (Moving Picture Experts Group) format, a MOV format, or an AVI format, etc., any data format can be used.

The encrypting part 22 encrypts the captured image generated by the imaging part 21. Then, the encrypting part 22 associates terminal identification information with the captured image that is encrypted. Here, the terminal identification information is information for identifying the terminal apparatus 20, and includes a character(s), a number(s), and a symbol(s), etc. In explanations below, the terminal identification information is also expressed as a terminal ID.

Then, the encrypting part 22 stores, to the temporary storage region 23, the captured image that is associated with the terminal identification information, and that are encrypted. Even if the terminal apparatus 20 comprises a storage apparatus such as a HDD (Hard Disk Drive), etc., the terminal apparatus 20 does not store the captured image. In addition, the terminal apparatus 20 does not store, in a temporary storage region, a captured image that is encrypted.

The authentication client part 24 requires the server apparatus 10 via the network 30 to authenticate a user who uses the terminal apparatus 20. For example, the authentication client part 24 may transmit information to identify the user who uses the terminal apparatus 20 (in the following, referred to as user identification information) to the server apparatus 10 via the network 30. Here, the user identification information is information for identifying the terminal apparatus 20, and may be configured to include at least a character(s), a number(s), or a symbol(s). Then, the authentication client part 24 received, from the server apparatus 10 via the network 30, a result of authentication of the user who uses the terminal apparatus 20.

The image transmitting part 25 transmits the captured image to the server apparatus 10. Concretely, the image transmitting part 25 transmits the captured image encrypted by the encrypting part 22 to the server apparatus 10. More concretely, the image transmitting part 25 transmits the captured image associating the terminal identification information with the encrypted capture image to the server apparatus 10.

In addition, in a case where the image transmitting part 25 transmitted the captured image to the server apparatus 10, the image transmitting part 25 deletes the captured image to the terminal apparatus 20. Concretely, in a case where the image transmitting part 25 transmitted, to the server apparatus 10, the captured image that the encrypting part 22 encrypted, the image transmitting part 25 deletes the captured image that is encrypted from the temporary storage region 23.

In addition, in a case where the server apparatus 10 received the captured image, the server apparatus 10 may transmit a signal of indication of finishing of reception to the terminal apparatus 20 that transmitted of the captured image. Then, in a case where the image transmitting part 25 received the signal of indication of finishing of reception from the server apparatus 10, the image transmitting part 25 may delete the captured image that is encrypted from the temporary storage region 23.

The screen image displaying part 26 is configured including a liquid crystal panel, and an electro luminescence panel, etc., and displays information so as to be visible for a user. Concretely, the screen image displaying part 26 displays screen image information transmitted from the server apparatus 10. Here, the screen image information means information about a screen image. In the image processing system 1 according to the present embodiment, the virtual terminal 11 of the server apparatus 10 generates the screen image information, and transmits the generated screen image information to the terminal apparatus 20.

The screen information receiving part 27 receives the screen image information from the server apparatus 10. The screen image information receiving part 27 may receive compressed screen image information from the server apparatus 10. Upon receiving the compressed screen image information, the screen image information receiving part 16 expands the compressed screen information, and outputs the screen image information to the screen image displaying part 26.

Next, details on an internal configuration of the server apparatus 10 will be described.

The server apparatus 10 comprises virtual terminals 11_1 to 11_n (n is a natural number less than 1), a database 12, a authentication server part 13, an image receiving part 14, a virtual terminal selecting part 15, a decrypting part 16, a determining part 17, an image modifying part 18, and a screen image transmitting part 19. For simplicity, FIG. 2 mainly shows modules relevant to the server apparatus 10 according to the present example embodiment.

Respective modules of the server apparatus 10 may be realized by a computer program that causes the server apparatus 10 to perform by a computer mounted on the server apparatus 10 by using its modules.

Virtual terminals 11_1 to 11_n control outputting the captured image. Concretely, respective virtual terminals 11_1 to 11_n correspond to a terminal apparatus(es) 20. The respective virtual terminals 11_1 to 11_n control outputting the captured image generated by the corresponding terminal apparatus 20. The virtual terminals 11_1 to 11_n may record information where the respective own virtual terminals 11_1 to 11_n and the terminal identification information of the terminal apparatus 20 are associated. In addition, the virtual terminals 11_1 to 11_n generate screen image information displayed on the corresponding terminal apparatus. In explanations below, the screen image information is just referred to as a screen image. In addition, in explanations below, in a case where it is not necessary to respective virtual terminals 11_1 to 11_n to distinguish each other, the respective virtual terminals 11_1 to 11_n are referred to as a virtual terminal 11.

The database 12 stores first image information that is extracted from an image(es), and that corresponds to the respective image(s). Here, in the image processing system 1 according to the present embodiment, the database 12 stores a feature(s) extracted from an image of a copyrighted material(s) as the first image information corresponding to the image. In explanations below, assumed that the database 12 stores information about the image of the copyrighted material(s) being a target of copyright protection.

The authentication server 13 determines whether or not to authenticate a user who uses the terminal apparatus 20. Concretely, the authentication server 13 determines whether or not to authenticate the user who uses the terminal apparatus 20.

Furthermore, the authentication part 13 comprises a storage part (not shown in the drawings) that records the user identification information and the terminal identification information associating each other. In a case where the authentication part 13 authenticates the user identification information, the authentication part 13 returns to a terminal apparatus 20 a result of the authentication and the terminal identification information corresponding to the user identification information.

The image receiving part 14 receives, from the terminal apparatus 20, the captured image that is encrypted.

In a case where the image receiving part 15 received the captured image, the virtual terminal selecting part 15 selects a virtual terminal based on the terminal identification being associated with the captured image. Concretely, the virtual terminal selecting part 15 collates the terminal identification information being associated with the captured image with the terminal identification information being associated with the virtual terminals 11_1 to 11_n, and selects the virtual terminal 11.

In a case where the image receiving part 14 received the captured image that is encrypted, the decrypting part 16 decrypts the captured image that is encrypted.

The determining part 17 determines whether or not the captured image received includes predetermined information (a predetermined subject, etc.). Concretely, first, the determining part 17 extracts second image information from the captured image decrypted by the decrypting part 16. Here, assumed that a method for extracting the first image information and a method for extracting the second image information are same. Namely, the determining part 17 extracts a feature(s) from the captured image as the second image information by using a same method as that for the first image information.

Then, the determining part 17 collates the first image information stored in the database 12 with the second image information included in the captured image received, and determines whether or not the captured image received includes the predetermined information. For example, the determining part 17 may calculate, as an evaluation value, a result of the collation between the first image information and the second image information. In a case where the calculated evaluation value exceeds (is more than) a predetermined threshold, the determining part 17 may determine the captured image includes the predetermined information. In addition, in a case where the calculated evaluation value is not more than a predetermined threshold, the determining part 17 may determine that the captured image does not include the predetermined information.

Here, assumed that the determining part 17 determines the captured image includes the predetermined information based on the result of the collation between the first image information and the second image information. And, as described above, assumed that the database 12 stores, as the first image information, the feature(s) extracted from an image of a copyrighted material(s). Accordingly, in case where it is determined that the captured image includes the predetermined information, it can be estimated that the captured image includes a copyrighted material(s).

In a case where the captured image received includes the predetermined information, the image modifying part 18 performs at least decreasing visibility of the captured image, or preventing outputting the captured image. Namely, in a case where the database 12 stores first information that are extracted from an image of a copyrighted material(s), and it is determined that the captured image includes a copyrighted material(s), the image modifying part 18 performs a predetermined process that includes at least decreasing visibility of the captured image, or preventing outputting the captured image.

For example, the image modifying part 18 may perform, as decreasing the visibility of the captured image, performing to mask the captured image, decreasing a resolution of the captured image, and so on. In addition, the image modifying part 18 may delete the captured image as preventing outputting the captured image. For example, when the image modifying part 18 performs masking, the image modifying part 18 may mask the captured image, or mask the copyrighted material(s) in the captured image with a color(s). In other ways, when the image modifying part 18 performs the masking, the image modifying part 18 may mask the captured image or the copyrighted material(s) with a predetermined character(s), a texture(s), etc. Note that, if it is possible to decrease the visibility of the captured image, and/or prevent outputting the captured image, a process(es) that the image modifying part 18 performs is not limited to the above processes, any process can be used.

Then, in a case where the captured image exists after the image modifying part 18 performs the above predetermined process(es) on the captured image, the image modifying part 18 stores the captured image in the virtual terminal 11 selected by the virtual terminal selecting part 15. Namely, the image modifying part 18 stores the captured image in the virtual terminal 11 corresponding to the terminal apparatus 20 that transmitted the captured image. Here, assumed that the image modifying part 18 stores the captured image on which the process of decreasing the visibility of the captured image, etc. was performed in the selected virtual terminal 11.

In addition, in a case where the image modifying part 18 does not perform the predetermined process on the captured image, the image modifying part 18 stores the captured image received in the selected virtual terminal 11. Note that, in a case where the image modifying part 18 deleted the captured image, it is reasonable that the image modifying part 18 cannot store the captured image.

The screen image information transmitting part 19 transmits screen image to the terminal apparatus 20 that transmitted the captured image. Concretely, the screen image information transmitting part 19 acquires the screen image information from the virtual terminal 11 selected by the virtual terminal selecting part 15. Then, the screen image transmitting part 19 compresses the acquired screen image, and packetizes the compressed screen image. Then, the screen image information transmitting part 19 transmits the packetized screen image to the terminal apparatus that transmitted the captured image via the network 30.

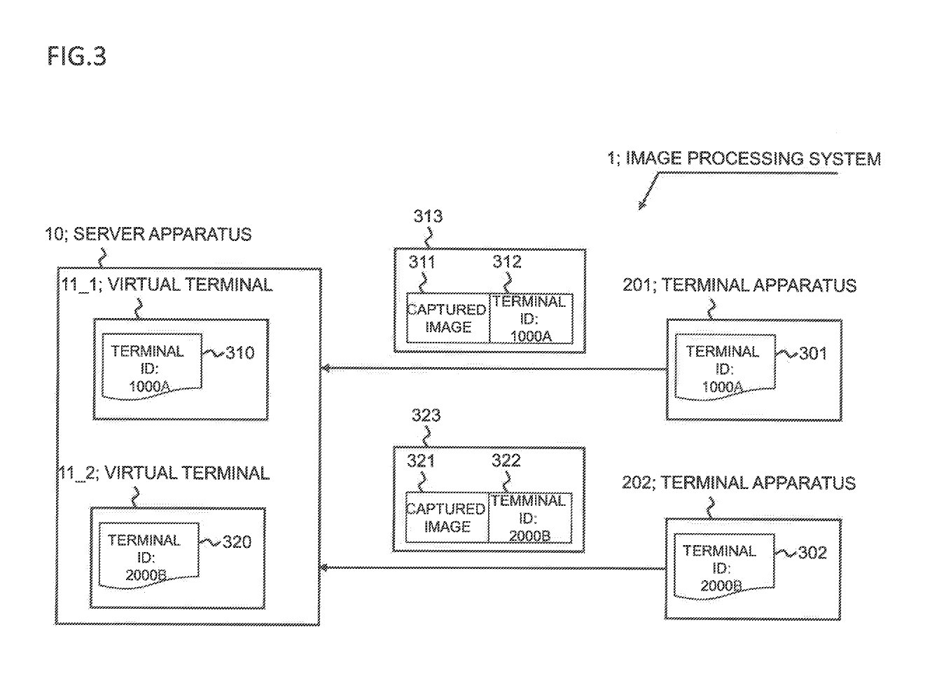

FIG. 3 is a block diagram illustrating an example of the image processing system 1. The image processing system 1 shown in FIG. 3 comprises terminal apparatuses 201 and 202, and the server apparatus 10 comprising the virtual terminals 11_1 and 11_2. Note that, assumed that an internal configuration of the terminal apparatuses 201 and 102 are same as that of the terminal apparatus 20 shown in FIG. 2.

In the image processing system 1 shown in FIG. 3, terminal identification information 301 (“terminal ID: 1000A”) is assigned to the terminal apparatus 201. In addition, in the image processing system 1 shown in FIG. 3, terminal identification information 310 (“terminal ID: 1000A”) is assigned to the virtual terminal 11_1. In addition, in the image processing system 1 shown in FIG. 3, terminal identification information 302 (“terminal ID: 2000B”) is assigned to the terminal apparatus 202. In addition, in the image processing system 1 shown in FIG. 3, terminal identification information 320 (“terminal ID: 2000B”) is assigned to the virtual terminal 11_2.

For example, assumed that the imaging part 21 of the terminal apparatus 201 generated the captured image 301. In that case, the image transmitting part 25 of the terminal apparatus 201 transmits, to the server apparatus 10, data 313 where the captured image 311 and the terminal identification information 312 (“terminal ID: 1000A”) are associated.

The virtual terminal selecting part 15 of the server apparatus 10 collates the terminal identification information being associated with the captured image 311 with the terminal identification information 310 and 320, then selects a virtual terminal. Here, the terminal identification information 312 associated with the captured image 311 and terminal identification information associated with the virtual terminal 11_1 are the “terminal ID: 1000A”. Accordingly, the virtual terminal selecting part 15 selects the virtual terminal 11_1 as the virtual terminal 11 corresponding to the terminal apparatus 201 that transmitted the captured image 311. Then, the virtual terminal 11_1 controls a process(es) including outputting the captured image, and so on.

In addition, assumed that the imaging part 21 of the terminal apparatus 202 generated the captured image 321. In that case, the image transmitting part 25 of the terminal apparatus 202 transmits, to the server apparatus 10, data 323 where the captured image 321 and the terminal identification information 323 (“terminal ID: 2000B”) are associated. Then, the virtual terminal selecting part 15 of the server apparatus 10 selects the virtual terminal 11_2 based on the terminal identification information 322 associated with the virtual terminal 11_2. Then, the virtual terminal 1_2 controls a process(es) including outputting the captured image 321, and so on.

Next, operations of the server apparatus 10 and the terminal apparatus 20 will be described. Note that, assumed that the database 12 stores a feature(s) that is extracted form an image of a copyrighted material(s) being a target of copyright protection.

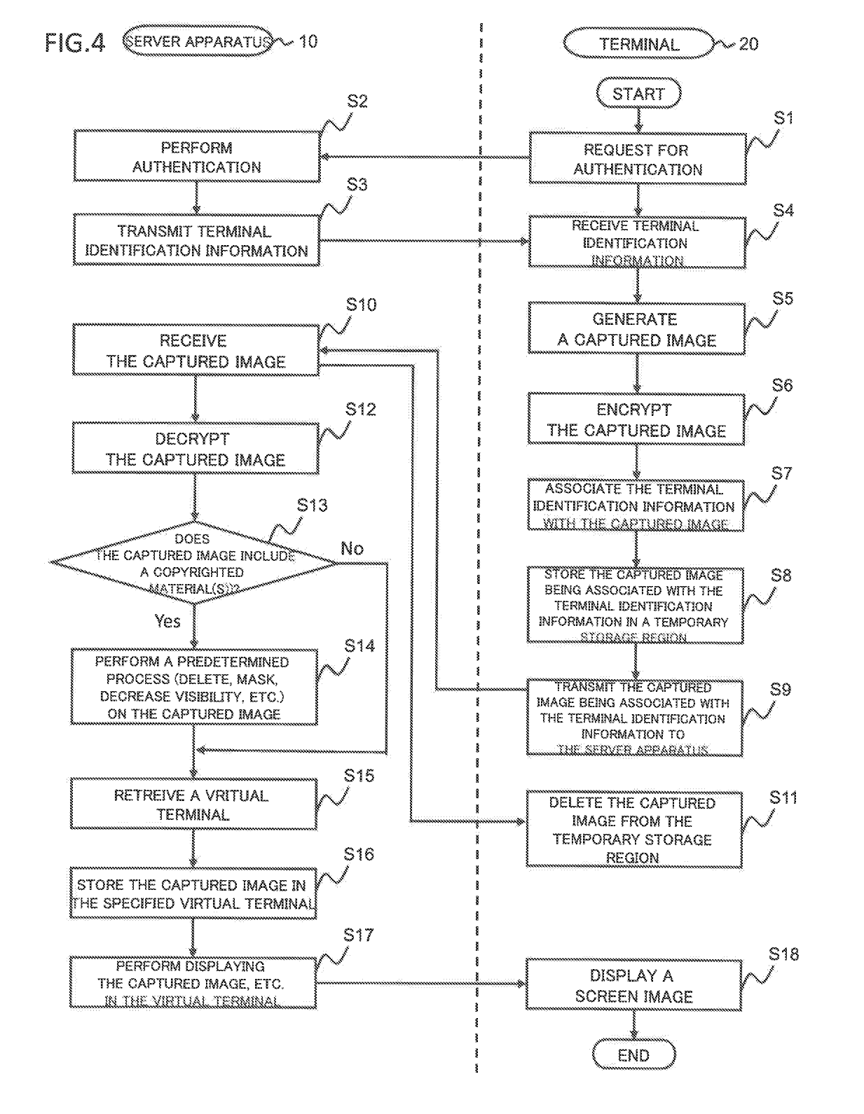

FIG. 4 is a flowchart of an example of operations of the server apparatus 10 and the terminal apparatus 20.

In step S1, the authentication client part 24 of the terminal apparatus 20 transmits a request for authentication to the server apparatus 10. For example, authentication client part 24 may transmit, to the server apparatus 10, the user identification information of a user who uses the terminal apparatus 20, and the request for authentication.

In step S2, the authentication server part 13 of the server apparatus 10 performs authentication. For example, in a case where the authentication server part 13 received the user identification information, the authentication server part 13 may determine whether or not to authenticate a user of the terminal apparatus 20. Then, in a case where the authentication server part 13 authenticate the user of the terminal apparatus 20, the authentication server part 13 retrieve the terminal identification information of the terminal apparatus 20 based on the user identification information referring to a storage part (not shown in the drawings).

In step S3, the authentication server part 13 of the server apparatus 10 transmits the terminal identification information to the terminal apparatus 20.

In step S4, the authentication client part 24 of the terminal apparatus 20 receives the terminal identification information from the server apparatus 10.

In step S5, the imaging part 21 of the terminal apparatus 20 generates the captured image. Concretely, the imaging part 21 captures image of a subject, and generates the captured image.

In step S6, the encrypting part 22 of the terminal apparatus 20 encrypts the captured image. In step S7, the encrypting part 22 associates the terminal identification information with the captured image. In step S8, the encrypting part 22 stores, in the temporary storage region 23, the captured image being associated with the terminal identification information.

In step S9, the image transmitting part 25 of the terminal apparatus 20 transmits, to the server apparatus 10, the captured image being associated with the terminal identification information. Here, the image transmitting part 25 transmits the captured image and the terminal identification information to the server apparatus 10.

Note that, in a case where the server apparatus 10 and the terminal apparatus 20 are not connected when the encrypting part stored the captured image in the temporary storage region 23, the image transmitting part 25 may transmit the captured image that is encrypted, etc. to the server apparatus 10 after the server apparatus 10 and the terminal apparatus 20 are connected.

For example, in a case where the server apparatus 10 and the terminal apparatus 20 are not connected, the image transmitting part 25 may attempt to connect the server apparatus 10 and the terminal apparatus 20. Then, if a connection between the server apparatus 10 and the terminal apparatus 20 succeeded, the terminal apparatus 20 may transmit the captured image that is encrypted, etc. to the server apparatus 10.

In other ways, in a case where the server apparatus 10 and the terminal apparatus 20 are not connected, the terminal apparatus 20 may be pending transmitting the captured image, etc. until the server apparatus 10 and the terminal apparatus 20 are connected. Then, a connection between the server apparatus 10 and the terminal apparatus 20 is established, the terminal apparatus 20 may transmit the captured image that is encrypted, etc. to the server apparatus 10.

In step S10, the image receiving part 14 of the server apparatus 10 receives the captured image. The image receiving part 14 transmits a signal of indication of finishing of reception of the captured image to the terminal apparatus 20 that transmitted the captured image. In step S11, in a case where the terminal apparatus 20 receives the signal of indication of finishing of reception of the captured image, the image transmitting part 25 deletes the captured image from the temporary storage region 23 of the terminal apparatus 20.

In step S12, the decrypting part 16 of the terminal apparatus 10 decrypts the captured image. Concretely. The captured image where the image receiving part 14 of the server apparatus 10 received is the captured image that is encrypted. Therefore, the decrypting part 16 decrypts the captured image that is encrypted, and, restores the captured image where the imaging part 21 of the terminal apparatus 20 generated.

In step S13, the determining part 17 of the server apparatus 10 determines whether or not the captured image includes a copyrighted material(s). Concretely, the determining part 17 extracts a feature(s) (second image information) from the captured image. Then, the determining part 17 collates first image information extracted from an image of a copyrighted material with a second feature(s) extracted from the captured image. Then, based on a result of the collation, the determining part 17 determines whether or not the captured image includes a copyrighted material that is registered in advance. Here, although there are various methods (algorithms) to collate a feature(s) extracted from an image, any method can be used.

In a case where the determining part 17 determines the captured image includes a copyrighted material(s) (Yes in the step S13), the process proceeds to step S14. On the other hand, in a case where the determining part 17 determines that the captured image does not include a copyrighted material(s) (No in the step S13), the process proceeds to step S15.

In step S14, the image modifying part 18 of the server apparatus 10 performs a predetermined process on the captured image, wherein the predetermined process includes deleting the captured image, masking, decreasing resolution of the captured image, etc. Then, the process proceeds to the step 15.

Here, a user may be able to determine (select) content of the predetermined process in advance. In that case, the terminal apparatus 120 transmits, to the server apparatus 10, the content of the process selected by the user, and user identification information. The server apparatus 10 may record the content of the process selected by the user, and the used identification information associating each other. Then the image modifying part 18 of the server apparatus 10 may specify the content of the process for the captured image based on the user identification information, and perform the specified process on the captured image.

In step S15, the virtual terminal selecting part 15 of the server apparatus 10 retrieves the virtual terminal 11. Concretely, the virtual terminal selecting part 15 specifies a corresponding virtual terminal 11 among the virtual terminals 11_1 to 11_n based on the terminal identification information being associated with the captured image.

In step S16, the image modifying part 18 of the server apparatus 10 stores the captured image in the specified virtual terminal 11. Here, in a case where the predetermined process was performed on the captured image in the step S14, the image modifying part 18 stores the captured image on which the predetermined process was performed in the specified virtual terminal 11. In addition, in a case where the predetermined process was not performed on the captured image in the step S14, the image modifying part 18 stores the captured image in the specified virtual terminal 11.

In step S17, the virtual terminal 11 performs a process(es) including displaying the captured image, and so on. The virtual terminal 11 generates the screen image of the captured image. For example, the virtual terminal 11 may generate the screen image of the captured image by using an application program, etc. that performs displaying an image. In the step S14, in a case where a predetermined process on the captured image is performed, the virtual terminal 11 generates the screen image information regarding the captured image on which the predetermined process was performed.

Then, the virtual terminal 11 transmits the generated captured image to a corresponding terminal apparatus 20. In step S18, the screen image displaying part 26 of the terminal apparatus 20 displays the received screen image information.

Here, in a case the captured image includes a copyrighted material(s), the image modifying part 18 of the server apparatus 10 performs a predetermined process (deleting, masking, decreasing a resolution of an image, and so on) on the captured image. Then, the screen image displaying part 26 displays the screen image where a process including a process of deleting the capture image, of masking on the captured image, of decreasing the resolution of the captured image, and so on is performed.

Note that, in a case where in the image modifying part 18 of the server apparatus 10 performed the predetermined process on the captured image, the server apparatus 10 may notify a user that the captured image was deleted or modified. In a case where the server apparatus notifies, to a user, that the captured image was deleted or modified, it is preferred to automatically notify the user by using an electronic mail (E-mail), or a message, etc. without a manual operation.

### Modification 1

As a modification 1 of the image processing system 1 according to the present embodiment, a gateway, etc. on a network instead of the server apparatus 10 may perform the predetermined process (deleting, masking, decreasing the resolution, and so on) on the captured image. Namely, functions (processes) of the server apparatus 10 may be distributed with apparatuses not less than two.

As described above, in a case where the captured image includes pre-registered image information (for example, a feature(s) extracted from an image of a copyrighted material), the image processing system 1 according to the present embodiment performs decreasing a visibility of the captured image, preventing outputting the captured image, and so on. As a result of performing this process, the image processing system 1 according to the present embodiment contributes to preventing publishing an image of a copyrighted material(s).

In addition, in the image processing system 1 according to the present embodiment, the server apparatus 10 performs image processing on the captured image. In addition, in the image processing system 1 according to the present embodiment, the server apparatus 10 stores the captured image. Namely, since the image processing system 1 according to the present embodiment is a thin client as it is called, thus decreases load on the terminal apparatus 20. Hence, the image processing system 1 according to the present embodiment contributes to appropriately managing the captured image while decreasing load on the terminal apparatus 20 used by a user.

In addition, in the image processing system 1 according to the present embodiment, associating respective terminal apparatuses 20 with respective virtual terminals 11, the virtual terminal 11 controls storing the captured image, outputting the captured image, and so on. Namely, in the image processing system 1 according to the present embodiment, even if the terminal apparatuses 20 not less than two exist, a different (independent) virtual terminal 11 controls storing the captured image, outputting the captured image, and so on. As a result of performing this process, even if the terminal apparatuses 20 not less than two exist, the image processing system 1 according to the present embodiment contributes to causing the server apparatus 10 to respectively control a process(es) on respective terminal apparatus 20 independently.

In addition, in the image processing system 1 according to the present embodiment, after generating a captured image, the terminal apparatus 20 automatically transmits (i.e., without a user operation) the captured image to the server apparatus 10. Then, the server apparatus 10 determines whether or not the captured image received includes a copyrighted material. Accordingly, the image processing system 1 according to the present embodiment contributes to easily and quickly determining whether or not a copyrighted material(s) is included in the captured image.

In addition, in the image processing system 1 according to the present embodiment, the server apparatus 10 determines whether or not the captured image includes a copyrighted material(s). Accordingly, the image processing system 1 according to the present embodiment contributes to preventing been avoiding of determining existence of the copyrighted material(s) in the captured image.

In addition, in the image processing system 1 according to the present embodiment, the captured image is not stored in the terminal apparatus 20. Accordingly, the image processing system 1 according to the present embodiment contributes to easily preventing that the captured image that includes a copyrighted material(s) is published by deleting the captured image data in the server apparatus 20.

### Second Example Embodiment

Next, details on a second example embodiment will be described with reference to the drawings.

The present embodiment is an embodiment that determines whether or not to perform a predetermined process on the captured image based on location information. Note that, the description that overlaps with the example embodiment described above will be omitted in the description of the present example embodiment. Further, the same signs are given to the elements same as those in the example embodiment described above and the explanation thereof will be omitted in the description of the present example embodiment. In addition, explanation regarding same effects as those of the example embodiment described above will be omitted in the description of the present example embodiment.

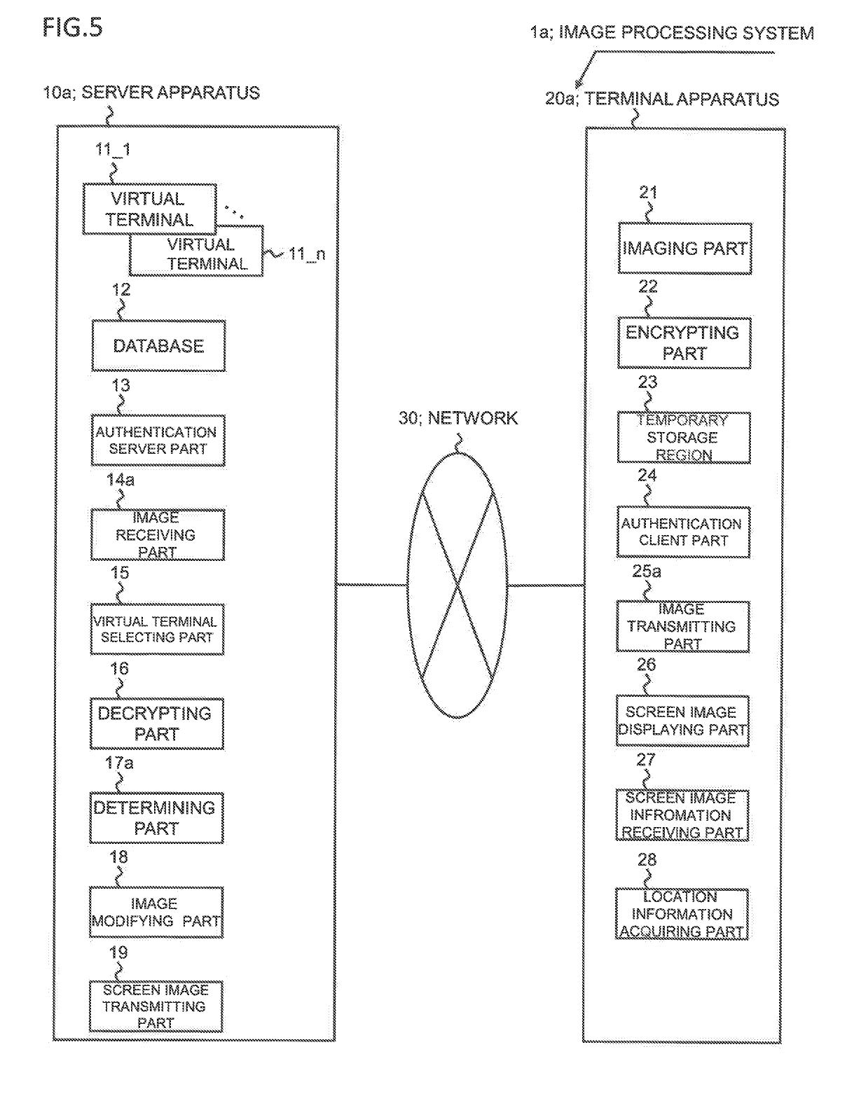

FIG. 5 is a block diagram illustrating an example of a total configuration of an image processing system la according to a second example embodiment. A different point between the image processing system la shown in FIG. 5 and the image information system 1 shown in FIG. 1 is a point where a terminal apparatus 20a comprises a location information acquiring part 28. In explanations below, details on differences from the first example embodiment will be described.

First, details on the terminal apparatus 20a according to the present example embodiment will be described.

The location information acquiring part 28 acquires location information. Concretely, in a case where the imaging part 21 generates a captured image, the location information acquiring part 28 acquires the location information. Here, assumed that the location information acquired by the location information acquiring part 28 indicates a location where the captured image generated (a location where a subject is captured as an image). For example, in a case where the terminal apparatus 20a connects to the server apparatus 10 via a wireless LAN (Local Area Network), the location information acquiring part 28 may specify an access point of the wireless LAN as the location information.

An image transmitting part 25a according to the present example embodiment transmits the captured image to the server apparatus 10a associating the location information with the captured image. Concretely, the image transmitting part 25a transmits the captured image to the server apparatus 10a associating the location information and the terminal identification information with the captured image.

Next, details on the server apparatus 10a according to the present example embodiment will be described.

An image receiving part 14a receives, from the terminal apparatus 20a, the captured image with which the location information is associated. Concretely, the image receiving part 14a, from the terminal apparatus 20a, the captured image with which the location information and the terminal identification information are associated.

A determining part 17a according to the present example embodiment determines whether or not to perform, on the captured image, a predetermined process including at least a process of decreasing visibility of the captured image, or of preventing outputting the captured image based on the location information being associated with the captured image. Concretely, in a case where the location information being associated with the captured image satisfies a predetermined condition, the determining part 17a performed the predetermined process on the captured image.

For example, in a case where the location information being associated with the captured indicates that the location information is within an area of a museum, the determining part 17a may determine that the captured image includes a copyrighted material(s). Then, the determining part 17a may perform, on the captured image including the copyrighted material(s), decreasing visibility of the captured image, preventing outputting the captured image, and so on.

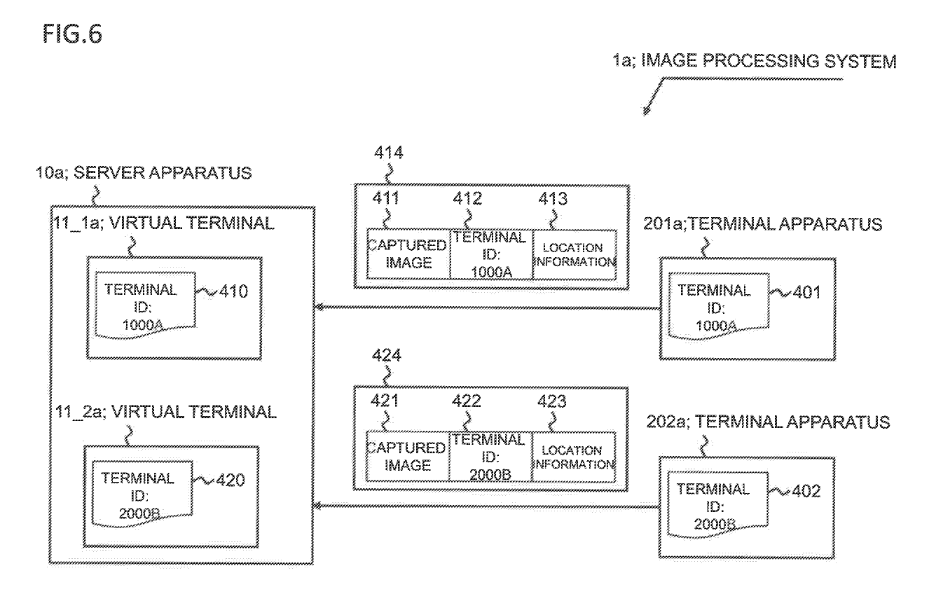

FIG. 6 is a block diagram illustrating an example of the image processing system 1a. The image processing system shown in FIG. 6 comprises terminal apparatuses 201a and 202a, and the server apparatus 10a comprising virtual terminals 11_1a and 11_2a. Note that, assumed that an internal configuration of the terminal apparatuses 201a and 202a are same as that of the terminal apparatus 20a.

In the image processing system shown in FIG. 6, terminal identification information 401 (“terminal ID: 1000A”) is assigned to the terminal apparatus 201a. In addition, the image processing system 1a, terminal identification information 410 (“terminal ID: 1000A”) is assigned to the virtual terminal 11_1a. In addition, in the image processing system 1a, terminal identification information 402 (“terminal ID: 2000B”) is assigned to the terminal apparatus 202a. In addition, in the image processing system 1a, terminal identification information 420 (“terminal ID: 2000B”) is assigned to the virtual terminal 11_2a.

For example, assumed that the imaging part 21 of the terminal apparatus 201a generated the captured image 411. In that case, the location information acquiring part 28 acquires location information 413 that indicates a position (location) where the captured image 411 is captured. Then, the image transmitting part 25 of the terminal apparatus 291 transmits, to the server apparatus 10a, data 414 with which the captured image 411, terminal identification information 412, and the location information 413 are associated.

The determining part 17a of the server apparatus 10a determines whether or not to perform a predetermined process on the captured image 411 based on the location information 413 being associated with the captured image. Then, a virtual terminal selecting part 15 of the server apparatus 10a selects the virtual terminal 11_1a based on the terminal identification information being associated with the captured image. Then, the virtual terminal 11_1a controls outputting the captured image, and so on.

In addition, assumed that the imaging part 21 of the terminal apparatus 202a generated the captured image 421. In that case, the location information acquiring part 28 of the terminal apparatus 202a acquires location information 432 indicating the captured location of the captured image. Then, the image transmitting part 25 of the terminal apparatus 202a transmits, to the server apparatus 10a, data 424 with which the captured image 421, terminal identification information 422, and location information 423 are associated. Then, the determining part 17a of the server apparatus 10a determines whether or not to perform the predetermined process on the captured image 421 based on location information 423. Then, the virtual terminal selecting part 15 of the server apparatus 10a selects the virtual terminal 11_2a based on the terminal identification information 422.

As described above, the image processing system la according to the present example embodiment determines whether or not to perform, on the captured image, decreasing visibility of the captured image, preventing outputting the captured image, etc. according to the location where the image is captured. Namely, the image processing system la according to the present example embodiment determines, according to the captured location of the captured image, whether or not the captured image includes a copyrighted material(s) where capturing its image is not allowed. Accordingly, even if it is obscure whether or not the captured image includes the copyrighted material(s) where capturing its image is not allowed, in the case where the location where the image is captured satisfies a predetermined condition, the image processing system la according to the present example embodiment performs, on the captured image, decreasing visibility of the captured image, and so on. Accordingly, the image processing system la according to the present example embodiment contributes to more certainly preventing that an image of a copyrighted material(s) is published.

A part of/a whole of the above example embodiment can be described as the following modes, but not limited to the following modes.

### Mode 1

As the image processing system according to the first aspect.

### Mode 2

The image processing system according to Mode 1, further comprising: a database that stores first image information that is extracted from an image(s), and that corresponds to the respective image(s), wherein the determining part collates the first image information stored in the database with second image information included in the captured image received, and determines whether or not the captured image received includes the predetermined information.

### Mode 3

The image processing system according to Mode 2, wherein the terminal apparatus further comprises: an encrypting part that encrypts the captured image generated by the imaging part; wherein the image transmitting part transmits the captured image encrypted by the encrypting part to the server apparatus; wherein the server apparatus further comprises: a decrypting part that, in a case where the image receiving part received the captured image that is encrypted, decrypts the captured image that is encrypted; and wherein the determining part extracts the second image information from the captured image decrypted by the decrypting part.

### Mode 4

The image processing system according to Mode 3, wherein the terminal apparatus further comprises: a temporary storage region that stores the captured image that is encrypted by the encrypting part; and wherein In a case where the image transmitting part transmitted the captured image that is encrypted by the encrypting part, the image transmitting part deletes the captured image that is encrypted from the temporary storage region.

### Mode 5

The image processing system according to any one of Modes 2 to 4, wherein the database stores a feature(s) extracted from an image of a copyrighted material(s) as the first image information.

### Mode 6

The image processing system according to any one of Modes 1 to 5, wherein the server apparatus further comprises: a virtual terminal(s) corresponding to the terminal apparatus(es); and wherein the virtual terminal(s) controls outputting the captured image.

### Mode 7

The image processing system according to Mode 6, wherein the image transmitting part transmits the captured image associating the captured image with terminal identification information; the virtual terminal records information where the own virtual terminal and the terminal identification information are associated; and the server apparatus further comprises: a virtual terminal selecting part that, in a case where the image receiving part received the captured image, selects the virtual terminal based on the terminal identification information; and wherein in a case where the captured image exists after the image modifying part performs the predetermined process on the captured image, the image modifying part stores the captured image in the virtual terminal selected by the virtual terminal selecting part.

### Mode 8

The image processing system according to any one of Modes 1 to 7, wherein the terminal apparatus further comprises: a location information acquiring part that acquires location information; wherein the image transmitting part transmits the captured image to the server apparatus associating the location information with the captured image; and wherein the determining part determines whether or not to perform, on the captured image, the predetermined process based on the location information being associated with the captured image.

### Mode 9

As the server apparatus according to the second aspect.

### Mode 10

As the controlling method for a server apparatus according to the third aspect.

### Mode 11

As the program according to the fourth aspect.

Note that, Modes 9 to 11 can be developed into Modes 2 to 8 as Mode 1.

It is to be noted that the various disclosures of the abovementioned Patent Literatures and Non-Patent Literature are incorporated herein by reference thereto. Modifications and adjustments of example embodiments are possible within the bounds of the entire disclosure (including the scope of the claims) of the present invention, and also based on fundamental technological concepts thereof. Furthermore, various combinations and selections of various disclosed elements (including respective elements of the respective claims, respective elements of the respective example embodiments, respective elements of the respective drawings, and the like) are possible within the scope of the entire disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular (explicit) description thereof.

### REFERENCE SIGNS LIST

1, 1a, 1000 image processing system
10, 10a, 1020 server apparatus
11_1 to 11_n, 11_2, 11_1a, 11_2a virtual terminal
12 database
13 authentication server part
14, 14a image receiving part
15 virtual terminal selecting part
16 decrypting part
17, 17a, 1021 determining part
18, 1022 image modifying part
19 screen image information transmitting part
20, 20a, 201, 201a, 202, 202a, 1010 terminal apparatus
21, 1011 imaging part (camera)
22 encrypting part
23 temporary storage part
24 authentication client part
25, 25a, 1012 image transmitting part
26 screen image displaying part
27 screen image receiving part
28 location information acquiring part
30 network
301, 302, 310, 312, 320, 322, 401, 402, 410, 412, 420, 422 terminal identification information
311, 321, 411, 421, 1001 captured image
313, 323, 414, 424 data
413, 423 location information

What is claimed is:

1. An image processing system, comprising:
a terminal apparatus(es); and
a server apparatus that connects to the terminal apparatus(es); wherein
the terminal apparatus comprises:
an imaging part that captures image of a subject, and generates a captured image; and
an image transmitting part that, in a case where the imaging part generated the captured image, transmits the captured image to the server apparatus, wherein
in a case where the image transmitting part transmitted the captured image to the server apparatus, the image transmitting part deletes the captured image from the own terminal apparatus; wherein
the sever apparatus comprises:
a determining part that determines whether or not the captured image received includes predetermined information; and
an image modifying part that, in a case where the captured image received includes predetermined information, performs a predetermined process including at least a process of decreasing visibility of the captured image, or of preventing outputting the captured image.

2. The image processing system according to claim 1, further comprising:
a database that stores first image information that is extracted from an image(s), and that corresponds to the respective image(s), wherein
the determining part collates the first image information stored in the database with second image information included in the captured image received, and determines whether or not the captured image received includes the predetermined information.

3. The image processing system according to claim 2, wherein
the terminal apparatus further comprises:
an encrypting part that encrypts the captured image generated by the imaging part;
wherein
the image transmitting part transmits the captured image encrypted by the encrypting part to the server apparatus; wherein
the server apparatus further comprises:
a decrypting part that, in a case where the image receiving part received the captured image that is encrypted, decrypts the captured image that is encrypted; and wherein
the determining part extracts the second image information from the captured image decrypted by the decrypting part.

4. The image processing system according to claim 3, wherein
the terminal apparatus further comprises:
a temporary storage region that stores the captured image that is encrypted by the encrypting part; and wherein
in a case where the image transmitting part transmitted the captured image that is encrypted by the encrypting part, the image transmitting part deletes the captured image that is encrypted from the temporary storage region.

5. The image processing system according to claim 1, wherein
the server apparatus further comprises:
a virtual terminal(s) corresponding to the terminal apparatus(es); and wherein
the virtual terminal(s) controls outputting the captured image.

6. The image processing system according to claim 5, wherein
the image transmitting part transmits the captured image associating the captured image with terminal identification information;
the virtual terminal records information where the own virtual terminal and the terminal identification information are associated; and
the server apparatus further comprises:
a virtual terminal selecting part that, in a case where the image receiving part received the captured image, selects the virtual terminal based on the terminal identification information; and wherein
in a case where the captured image exists after the image modifying part performs the predetermined process on the captured image, the image modifying part stores the captured image in the virtual terminal selected by the virtual terminal selecting part.

7. The image processing system according to claim 1, wherein
the terminal apparatus further comprises:
a location information acquiring part that acquires location information; wherein
the image transmitting part transmits the captured image to the server apparatus associating the location information with the captured image; and wherein
the determining part determines whether or not to perform, on the captured image, the predetermined process based on the location information being associated with the captured image.

8. A server apparatus, comprising:
an image receiving part that receives a captured image from a terminal apparatus;
a determining part that determines whether or not the captured image received includes predetermined information; and
an image modifying part that, in a case where the captured image received includes the predetermined information, performs a predetermined process including at least a process of decreasing visibility of the captured image, or of preventing outputting the captured image.

9. A controlling method for a server apparatus comprising an image receiving part that receives an image from a terminal apparatus to perform:
determining whether or not the image received includes predetermined information; and
performing a predetermined process including at least a process of decreasing visibility of the captured image, or of preventing outputting the captured image.

10. A non-transitory computer readable recoding medium storing a program causing a computer that controls a server apparatus comprising an image receiving part that receives an image from a terminal apparatus, to execute the processings of:
determining whether or not the image received includes predetermined information; and
performing a predetermined process including at least a process of decreasing visibility of the captured image, or of preventing outputting the captured image.
